(19) United States
(12) Patent Application Publication
(10) Pub. No.: US 2023/0217204 A1
(43) Pub. Date: Jul. 6, 2023

(54) USER TRACKING HEADREST AUDIO CONTROL

(71) Applicant: Apple Inc., Cupertino, CA (US)

(72) Inventors: Daniel K. BOOTHE, San Francisco, CA (US); Onur I. ILKORUR, Redwood City, CA (US); Martin E. JOHNSON, Los Gatos, CA (US); Christopher WILK, Los Gatos, CA (US); Andrea Baldioceda OREAMUNO, Cupertino, CA (US); Sanjana WADHWA, Cupertino, CA (US)

(21) Appl. No.: 18/082,554

(22) Filed: Dec. 15, 2022

Related U.S. Application Data
(60) Provisional application No. 63/296,833, filed on Jan. 5, 2022.

(51) Int. Cl. H04S 7/00; G10K 15/10; H04R 1/02

(52) U.S. Cl. CPC H04S 7/303; G10K 15/10; H04R 1/02; H04S 2400/13

(57) ABSTRACT

Implementations of the subject technology provide user tracking headrest audio control. For example, a seat may have a headrest and one or more speakers mounted to the headrest for providing audio output to an occupant of the seat. Because the head of the occupant may be disposed in the near field of the headrest speakers when the occupant is seated in the seat, movements of the occupant's head and/or ears may affect the acoustic experience of the occupant. Aspects of the subject technology provide for modifications to audio output(s) from one or more speaker(s) mounted in a headrest, based on tracking of the location of the occupant's head and/or ears relative to the location(s) of the speaker(s).

### CROSS REFERENCE TO RELATED APPLICATIONS

This application claims the benefit of priority to U.S. Provisional Patent Application No. 63/296,833, entitled, “User Tracking Headrest Audio Control”, filed on Jan. 5, 2022, the disclosure of which is hereby incorporated herein in its entirety.

### TECHNICAL FIELD

The present description relates generally to acoustic devices, including, for example, user tracking headrest audio control.

### BACKGROUND

Acoustic devices can include speakers that generate sound and microphones that detect sound. Acoustic devices are often deployed in enclosed spaces, such as conference rooms, to provide audio output to the population of occupants in the enclosed space.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a top view of an example apparatus having an enclosed space and speakers, including speakers disposed in a headrest of a seat within the enclosed space, in accordance with implementations of the subject technology.

FIG. 4 illustrates a top view of the example apparatus of FIG. 3 providing user tracking headrest audio control in accordance with implementations of the subject technology.

FIG. 5 illustrates a top view of an example seat with an occupant during user tracking headrest audio control based on a movement of a head of the occupant in accordance with implementations of the subject technology.

FIG. 6 illustrates a top view of an example seat with an occupant during user tracking headrest audio control based on a rotation of a head of the occupant in accordance with implementations of the subject technology.

FIG. 7 illustrates a top view of an example seat with an occupant during headrest noise cancelling audio control for in accordance with implementations of the subject technology.

FIG. 8 illustrates a top view of an example seat with an occupant during user tracking headrest noise cancelling audio control in accordance with implementations of the subject technology.

FIG. 9 illustrates a top view of an example seat with an occupant during user tracking headrest noise cancelling audio control localized to the ears of the occupant in accordance with implementations of the subj ect technology.

FIG. 10 illustrates a flow chart of example operations that may be performed for user tracking headrest audio control in accordance with implementations of the subject technology.

FIG. 11 illustrates a top view of an example headrest having headrest speakers coupled to horns in accordance with implementations of the subject technology.

FIG. 12A illustrates a side view of an example horn for a headrest speaker in accordance with implementations of the subject technology.

FIGS. 12B and 12C illustrate cross-sectional areas of openings of a horn for a headrest speaker in accordance with implementations of the subject technology.

FIG. 13 illustrates a schematic diagram of a data flow for providing distributed reverb in accordance with implementations of the subject technology.

FIG. 14 illustrates a flow chart of example operations that may be performed for providing distributed reverb in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subj ect technology.

Acoustic devices, such as speakers, can be deployed at various locations within an enclosure that defines an enclosed space, for providing audio output to an occupant (sometimes referred to herein as a user) within the enclosed space. In one or more implementations, a seat within the enclosure may be provided with a headrest. In various implementations, a headrest may be a separate headrest that is attached to a seat body of a seat (e.g., removably attached to a seat back and/or adjustable to various head heights), or may be an integrally formed portion of a seat, such as a protruding top extension of the seat body arranged to interface with a head of a person seated in the seat, or merely a top end of seatback or seat body. One or more speakers can be disposed within the headrest. Headrest speakers can be useful, for example, for providing personalized audio that is intended only for the occupant of the seat to which the headrest is mounted, for providing a surround channel intended to be perceived by the occupant as originating behind the occupant, or for providing an ambience channel to the occupant (as examples).

However, because the headrest speakers can be located close to the head of a user/occupant in the seat having the headrest, the user's head and ears may be located within the near field of the headrest speakers. When the user's head and ears are located within the near field of the headrest speakers, movement of the user's head and/or ears can have a noticeable effect on the acoustic experience of the user/occupant. For example, in the near field, the audio output received by the user/occupant can change by approximately one decibel for each centimeter of head and/or ear movement. In contrast, audio output from another speaker disposed separately from the headrest (e.g., such that the user/occupant is in the far field of the other speaker) may not be noticeably different to the user/occupant when the user/occupant moves less than a few centimeters (e.g., less than 30 cm or less than 10 cm). For this reason, when an occupant seated in a seat having speakers mounted in a headrest of the seat moves, the balance between the speakers mounted in the headrest, and a speaker disposed separately from the headrest can change in a way that is noticeable to the occupant. Similarly, when an occupant seated in a seat having speakers mounted in a headrest of the seat moves in certain ways (e.g., by turning their head), the balance between some of the speakers mounted in the headrest and other speakers mounted in the headrest can also change in a way that is noticeable to the occupant.

Implementations of the subject technology described herein provide for user tracking headrest audio control. The user tracking headrest audio control described herein can determine and/or track the location of the head and/or ears of an occupant of a seat, and adjust and/or modify the audio output of one or more headrest speakers relative to the audio output of one or more other headrest speakers, and/or relative to another speaker separate from the headrest. In this way, the user tracking headrest audio control described herein can provide an occupant, in a seat with headrest speakers, with a consistent acoustic experience independent of normal head movements of the occupant.

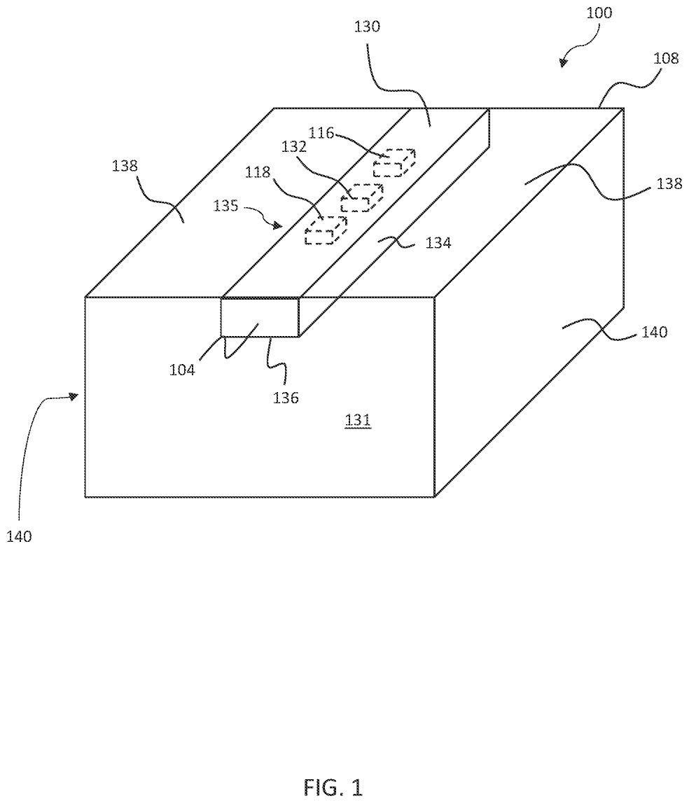

An illustrative apparatus including one or more speakers is shown in FIG. 1. In the example of FIG. 1, an apparatus 100 includes an enclosure 108 and a structural support member 104. The enclosure may (e.g., at least partially) define an enclosed environment 131. In the example of FIG. 1, the enclosure 108 includes top housing structures 138 mounted to and extending from opposing sides of the structural support member 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the structural support member 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the structural support member 104 may be formed from a curved glass structure. In this and/or other implementations, the sidewall housing structure 140 and/or other portions of the enclosure 108 may be or may include a reflective surface (e.g., an acoustically reflective surface).

As illustrated in FIG. 1, the apparatus 100 may include various components such as one or more safety components 116, one or more speakers 118, and/or one or more other components 132. In the example of FIG. 1, the safety component 116, the speaker 118, and the other component 132 are mounted in a structural space 130 at least partially within the structural support member 104. The other component 132 may include, as examples, one or more displays, microphones, or more cameras, and/or one or more sensors. The cameras and/or sensors may be used to identify an occupant within the enclosed environment 131, to determine the location of an occupant within the enclosed environment 131, and/or to determine the location of at least a portion of a head (e.g., the entire head or one or both ears) of an occupant within the enclosed environment 131. It is also contemplated that one or more safety components 116, one or more speakers 118, and/or one or more other components 132 may also, and/or alternatively, be mounted to the enclosure 108, and/or to and/or within one or more other structures of the apparatus 100. As shown in FIG. 1, the structural support member 104 may include a first side 134, an opposing second side 135, and a bottom surface 136 that faces an interior of the enclosed environment 131 defined by the enclosure 108.

In various implementations, the apparatus 100 may be implemented as a stationary apparatus (e.g., a conference room or other room within a building) or a moveable apparatus (e.g., a vehicle such as a train car, an airplane, an autonomous vehicle, a boat, a ship, a helicopter, etc.) that can be temporarily occupied by one or more human occupants and/or one or more portable electronic devices. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats.

In one or more use cases, it may be desirable to provide audio content to one or more occupants within the enclosed environment 131. The audio content may include general audio content intended for all of the occupants and/or personalized audio content for one or a subset of the occupants. The audio content may be generated by the apparatus 100, or received by the apparatus from an external source or from a portable electronic device within the enclosed environment 131. For example, in implementations in which the apparatus 100 includes speakers (e.g., headrest speakers) disposed such that an occupant's head may be disposed within the near field of the speakers, it may be desirable operate those speakers to generate personalized audio output (notifications for that particular occupant, or surround and/or ambience channel output) that is audible by an occupant in the seat having the headrest, and not by other occupants within the enclosure 108. In these and/or other use cases, it may be desirable to be able to adjust the audio output of one or more headrest speakers based on a location of the occupant's head, and/or a portion thereof (e.g., a location of one or both of the occupant's ears).

In one or more implementations, it may be desirable to be able to direct the audio content, or a portion of the audio content, to one or more particular locations within the enclosed environment 131 and/or to suppress the audio content and/or a portion of the audio content at one or more other particular locations within the enclosed environment 131. In various examples, the speaker 118 may be implemented as a directional speaker (e.g., a directional speaker having sound-suppressing acoustic ducts, a dual-directional speaker, or an isobaric cross-firing speaker) or speaker of a beamforming speaker array, or any other speaker.

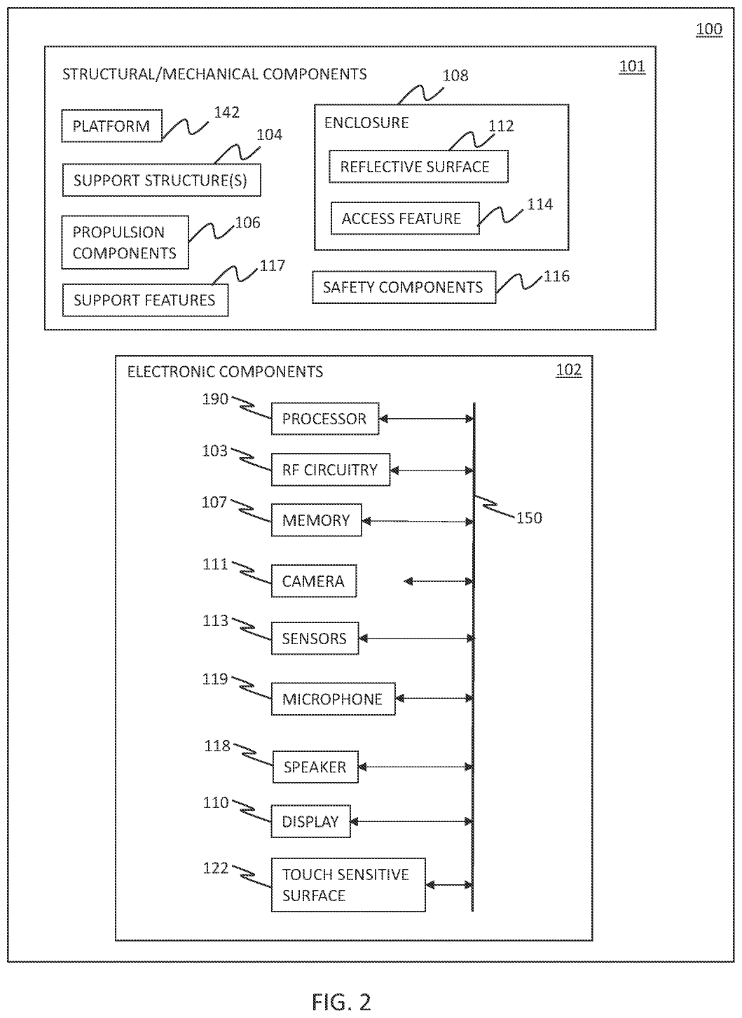

In various implementations, the apparatus 100 may include one or more other structure, mechanical, electronical, and/or computing components that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the structural support member 104, and the safety component 116 of FIG. 1. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed environment 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed environment 131 of FIG. 1.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, radar sensors, ranging sensor such as LIDAR sensors, depth sensors, temperature sensors, humidity sensors, etc. which may also be implemented in the other components 132 of FIG. 1), one or more microphones such as microphone 119, one or more speakers such as speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, cameras 111 and/or sensors 113 may be used to identify an occupant within the enclosed environment 131, to determine the location of an occupant within the enclosed environment 131, and/or to determine the location of at least a portion of a head (e.g., the entire head or one or more ears) of an occupant within the enclosed environment 131. For example, one or more cameras 111 may capture images of the enclosed environment 131, and the processor 190 may use the images to determine whether each seat within the enclosed environment 131 is occupied by an occupant. In various implementations, the processor 190 may use the images to make a binary determination of whether a seat is occupied or unoccupied, or may determine whether a seat is occupied by a particular occupant. In one or more implementations, the occupant can be actively identified by information provided by the occupant upon entry into the enclosed environment 131 (e.g., by scanning an identity card or a mobile device acting as an identity card with a sensor 113, or by facial recognition or other identity verification using the cameras 111 and/or the sensors 113), or passively (e.g., by determining that a seat is occupied and that that seat has been previously reserved for a particular occupant during a particular time period, such as by identifying an occupant of a seat as a ticketholder for that seat).

In various implementations, the processor 190 may use the images and/or sensor data such as depth sensor data to determine the location of the occupants head and/or the location of the occupant's left ear and/or right ear. In one or more implementations, the cameras 111 may include an optical wavelength camera and/or an infrared camera. In one or more implementations, the cameras 111 may include one or more light sources such as an optical wavelength light source and/or an infrared light source (e.g., for non-visibly illuminating the user's head for an infrared camera for determining the location of the user's head and/or or a portion thereof in the dark, such as at night and/or when one or more interior lights in the enclosure 108 are powered off).

Communications circuitry, such as RF circuitry 103, optionally includes circuitry for communicating with electronic devices, networks, such as the Internet, intranets, and/or a wireless network, such as cellular networks and wireless local area networks (LANs). RF circuitry 103 optionally includes circuitry for communicating using near-field communication and/or short-range communication, such as Bluetooth®. RF circuitry 103 may be operated (e.g., by processor 190) to communicate with a portable electronic device in the enclosed environment 131.

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118. In one or more implementations, the apparatus 100 may include multiple displays, such as multiple displays each facing a respective occupant location within the enclosure 108, for outputting video content to an occupant at that respective occupant location.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal—oxide—semiconductor (CMOS) sensors operable to obtain images within the enclosed environment 131 and/or of an environment external to the enclosure 108. Camera 111 may also optionally include one or more infrared (IR) sensor(s), such as a passive IR sensor or an active IR sensor, for detecting infrared light from within the enclosed environment 131 and/or of an environment external to the enclosure 108. For example, an active IR sensor includes an IR emitter, for emitting infrared light. Camera 111 also optionally includes one or more event camera(s) configured to capture movement of objects such as portable electronic devices and/or occupants within the enclosed environment 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed environment 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. Sensors 113 may also, or alternatively, include one or more scanners (e.g., a ticket scanner, a fingerprint scanner or a facial scanner), one or more depth sensors, one or more motion sensors, one or more temperature or heat sensors, or the like. In some examples, one or more microphones such as microphone 119 may be provided to detect sound from an occupant within the enclosed environment 131 and/or from one or more audio sources within the enclosure 108 and/or external to the enclosure 108. In some examples, microphone 119 includes an array of microphones that optionally operate in tandem, such as to identify ambient noise or to locate the source of sound in space. In one or more implementations, the processor 190 may process an audio signal from microphone 119, and may use the audio signal to operate one or more speakers, such as speaker 118, mounted in a headrest of a seat within the enclosure 108 to generate a noise cancelling audio output that generates a region of (e.g., relative) quiet within the enclosure 108.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, speaker 118 may be implemented as an omnidirectional speaker, a directional speaker (e.g., a directional speaker having sound-suppression acoustic ducts, a dual-directional speaker, or an isobaric cross-firing speaker), a speaker of a beamforming speaker array, or any other speaker having the capability (e.g., alone or in cooperation with one or more other speakers) to direct and/or beam sound to one or more desired locations, or any other speaker.

For example, in one or more implementations, the speaker 118 may be implemented with an acoustic port through which sound (e.g., generated by a moving diaphragm or other sound-generating component) is projected, a back volume, and one or more sound-suppression acoustic ducts fluidly coupled to the back volume and configured to output sound from the back volume. Because the sound from the back volume will have a polarity (e.g., a negative polarity) that is opposite to a polarity (e.g., a positive polarity) output from the acoustic port, the sound from the back volume may cancel a portion of the sound from the acoustic port, in one or more directions defined by the arrangement of the one or more sound-suppression acoustic ducts. Each sound-suppressing acoustic duct may include one or more slots that aid in the directivity of the sound projected from that sound-suppressing acoustic duct.

As another example, speaker 118 may be implemented as a dual-directional speaker that includes a sound-generating element mounted between a pair of acoustic ducts. Sound generated by the sound-generating element may project sound into an aperture at the center of a channel housing that can then propagate down each of the acoustic ducts. Each acoustic duct may include one or more slots that aid in the directivity of the sound projected from that acoustic duct.

As another example, speaker 118 may be implemented as an isobaric cross-firing speaker that includes a housing defining a back volume, a first speaker diaphragm having a first surface adjacent the back volume and an opposing second surface facing outward, and a second speaker diaphragm having a first surface adjacent the back volume (e.g., the same back volume, which may be referred to herein as a shared back volume) and an opposing second surface facing outward at an angle different from the angle at which the first speaker diaphragm faces. In this configuration, in operation, the first speaker diaphragm projects sound in a first direction and the second speaker diaphragm projects sound in a second direction different from the first direction. The first speaker diaphragm and the second speaker diaphragm can be operated out of phase so that the sound generated by the second speaker diaphragm cancels at least a portion of the sound generated by the first speaker diaphragm at a location toward which the second speaker diaphragm faces.

As another example, the speaker 118 may be a speaker of a beamforming speaker array. In a beamforming speaker array, multiple speakers of the array can be operated to beam one or more desired sounds toward one or more desired locations within the enclosed environment 131.

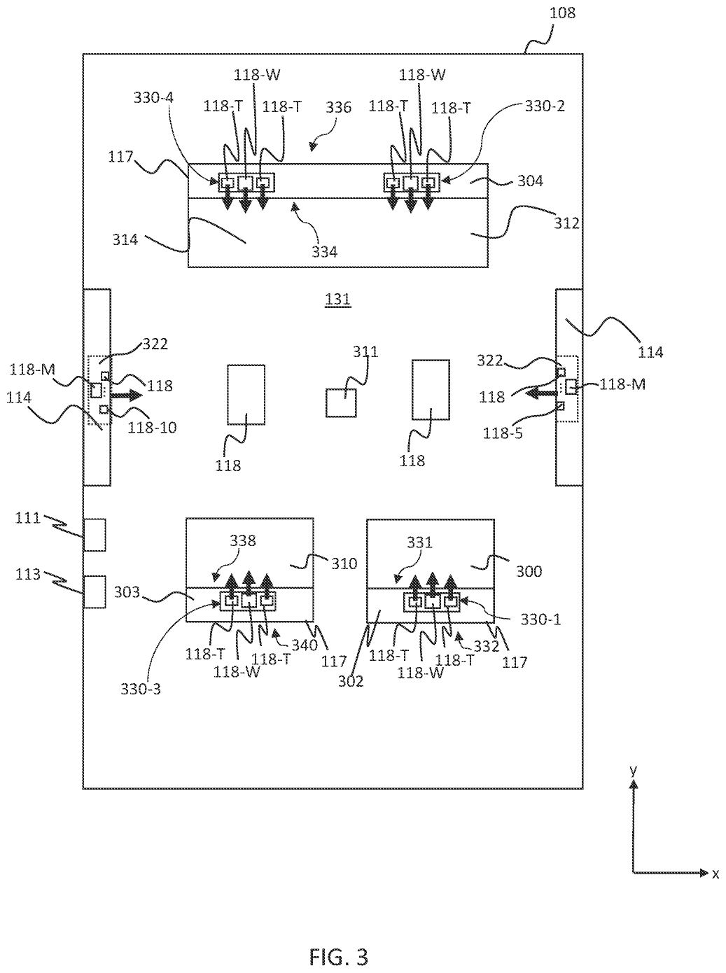

FIG. 3 illustrates a schematic top view of an example implementation of the apparatus 100 in which various speakers 118 (e.g., in one or more of the implementations described herein) are disposed at various locations within the apparatus 100. In the example of FIG. 3, the apparatus 100 includes the enclosure 108, and a seat 300 within the enclosure 108. As shown, the seat 300 may have a seat back 302 with a first side 331 configured to interface with an occupant within the enclosure (e.g., when the occupant is seated on the seat 300 and resting their back against the seat back 302), and an opposing second side 332. As indicated, the seat 300 may be an implementation of the support feature 117 of FIG. 2. In the example of FIG. 3, the seat 300 faces in the positive y direction indicated in the figure (merely for convenience of the present description).

As shown, the seat 300 includes a headrest 330-1. In various implementations, the headrest 330-1 may be permanently or removably attached to the seat back 302, or may be formed for a portion of the seat back 302. In the example of FIG. 3, headrest 330-1 includes multiple speakers mounted thereto. In this example, headrest 330-1 includes two tweeters 118-T and one woofer 118-W. However, this is merely illustrative, and the headrest 330-1 may include less than two or more than two tweeters, more than one woofer, and/or one or more other speakers, such as mid-range speakers, in various implementations. In various use cases, the speakers mounted to the headrest 330-1 may be operated individually or in coordination with each other and/or with one or more other speakers 118 of the apparatus. In one or more use cases, two or more of the speakers mounted to the headrest 330-1 may be operated as a beamforming speaker array to beam one or more audio outputs corresponding to one or more audio channels toward one or more locations within the enclosure 108 (e.g., including a location at or near an occupant's head, left ear and/or right ear, based on a determined location of the occupant's head, left ear and/or right ear).

In the example of FIG. 3, the apparatus 100 also includes a seat 310 facing in substantially the same direction (e.g., facing in the positive y direction) as the seat 300 (e.g., and having a seat back 303 with a first side 338 configured to interface with an occupant within the enclosure (e.g., when the occupant is seated on the seat 310 and resting their back against the seat back 303), and an opposing second side 340. In this example, the apparatus 100 also includes a seat 312 and a seat 314 having a seat back 304 and facing (e.g., in the negative y direction) substantially toward the seat 300 and the seat 310 (e.g., facing in a substantially opposite direction to the direction in which the seat 300 and the seat 310 face) and having a seat back 304 with a first side 334 configured to interface with an occupant within the enclosure, such as when the occupant is seated on the seat 312 or the seat 314 and resting their back against the seat back 304, and having an opposing second side 336. In the example of FIG. 3, the seat 312 includes a headrest 330-2 having two tweeters 118-T and one woofer 118-W, the seat 310 includes a headrest 330-3 having two tweeters 118-T and one woofer 118-W, and the seat 314 includes a headrest 330-4 having two tweeters 118-T and one woofer 118-W.

In the example of FIG. 3, headrest 330-2, headrest 330-3, and headrest 330-4 each include two tweeters 118-T and one woofer 118-W. However, this is merely illustrative, and headrest 330-2, headrest 330-3, and/or headrest 330-4 may include less than two or more than two tweeters, more than one woofer, and/or one or more other speakers, such as mid-range speakers, in various implementations. In the example of FIG. 3, wide arrows indicate a direction in which a speaker substantially faces (e.g., the direction toward which a sound-generating element of a speaker is physically directed). In various use cases, the speakers mounted to the headrest 330-2, headrest 330-3, and/or headrest 330-4 may be operated individually or in coordination with each other and/or with one or more other speakers 118 of the apparatus. In one or more use cases, two or more of the speakers mounted to headrest 330-2, headrest 330-3, and/or headrest 330-4 may be operated as a beamforming speaker array to beam one or more audio outputs corresponding to one or more audio channels toward one or more locations within the enclosure 108 (e.g., including a location at or near an occupant's head, left ear and/or right ear, based on a determined location of the occupant's head, left ear and/or right ear, even in cases in which the individual speakers being operated as a beamforming speaker array do not physically face the location to which the audio output is being beamed).

In the example of FIG. 3, the apparatus 100 includes speakers 118 at various locations. It is appreciated that one, any sub-combination, or all, of the speakers 118 shown in FIG. 3 may be implemented in the apparatus 100. It is also appreciated that additional speakers 118 may be implemented in the apparatus 100 at one or more other locations, and the locations of the speakers 118 of FIG. 3 are merely illustrative.

In the example of FIG. 3, the apparatus 100 includes a speaker 118 disposed between the seat 300 and the seat 312, and a speaker 118 disposed between the seat 310 and the seat 314. In this example, the speaker 118 disposed between the seat 300 and the seat 312, and the speaker 118 disposed between the seat 310 and the seat 314 may be implemented as a directional speaker (e.g., a directional speaker having one or more sound-suppressing acoustic ducts, a dual-directional speaker having a pair of acoustic ducts, or an isobaric cross-firing speaker, or any other directional speaker), configured to direct audio output toward one or more particular locations within the enclosed environment 131, such as the location of one of the seats within the enclosure 108.

In the example of FIG. 3, the apparatus 100 includes a beamforming speaker array 322 (e.g., including multiple speakers 118 arranged in one or more rows) mounted in an access feature 114 (e.g., a first door on a first side of the enclosure 108), and a beamforming speaker array 322 mounted in another access feature 114 (e.g., a second door on an opposing second side of the enclosure 108). Each of the beamforming speaker arrays 322 can be operated to beam one or more audio outputs (e.g., multiple audio outputs corresponding to multiple respective audio channels) to one or more desired locations within the enclosed environment 131. In one or more implementations, the speaker(s) 118 (e.g., including one or more speakers 118 implemented in the beamforming speaker array(s) 322) may be operated (e.g., by the processor 190) to in coordination with one or more speakers mounted in headrest 330-1, headrest 330-2, headrest 330-3, and/or headrest 330-4. As illustrated in FIG. 3, the beamforming speaker arrays 322 may include speakers of various sizes, such as multiple speakers 118 implemented as tweeters, and one or more lower frequency speakers (e.g., having relatively larger sizes than the size of the tweeters), such as a mid-range speaker 118-M.

In the example of FIG. 3, the apparatus includes four seats including headrests with speakers mounted thereto. However, this is merely illustrative, and, in other implementations, fewer than four, or more than four seats and/or fewer that four headrests with speakers or more than four headrests with speakers may be included within the enclosure 108.

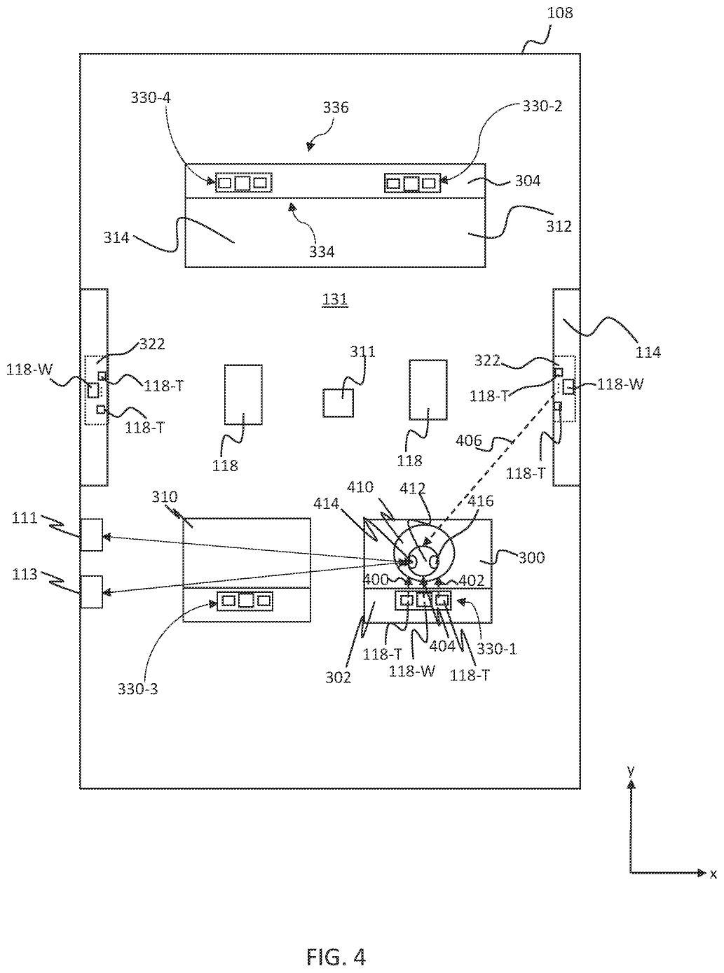

FIG. 4 illustrates an example use case in which occupant 410 is seated in, for example, the seat 300. In this example, the apparatus 100 includes the enclosure 108, the seat 300 within the enclosure 108 and having the headrest 330-1, multiple speakers (e.g., two tweeters 118-T and one woofer 118-W) mounted in the headrest 330-1, one or more additional speakers (e.g., the tweeters 118-T and mid-range speaker 118-M in the access features 114, the speaker(s) 118 disposed between the seats within the enclosure, the central speaker 311, and/or any other speaker(s)) within the enclosure 108 and separate from the headrest 330-1, a sensor (e.g., implemented as one of sensors 113 and/or one or more cameras 111), and a computing component (e.g., processor 190).

In this example, the apparatus 100 (e.g., the processor 190) may determine, based on a sensor signal from the sensor, a location of at least a portion of a head 412 of an occupant 410 within the enclosure 108. In one or more implementations, the sensor includes camera 111 that captures an image of the occupant 410, and the apparatus determines the location of at least the portion of the head 412 of the occupant 410 using computer vision techniques applied to the image. In one or more implementations, the sensor may also include a light source, such as a visible light source or an infrared light source, that illuminates the head 412 of the occupant 410 to facilitate image capture even in low light conditions within the enclosure 108. In one or more implementations, the sensor also, or alternatively, includes a depth sensor or a ranging sensor that generates sensor signals that can be used for object detection, mapping, and/or determining the location of at least a portion of the head 412 of the occupant 410.

In one or more implementations, that apparatus 100 may determine the location of the head 412 of the occupant 410. In one or more implementations, the apparatus 100 may also, or alternatively, determine the location of the left ear 414 of the occupant 410 and/or the location of the right ear 416 of the occupant 410. In one or more implementations, the apparatus 100 may determine the location of the head 412, the left ear 414, and/or the right ear 416 of the occupant 410 as an absolute location in a coordinate system anchored to the apparatus 100, the sensors 113, the camera(s) 111, and/or the enclosure 108. In one or more implementations, the apparatus 100 may determine the location of the head 412, the left ear 414, and/or the right ear 416 of the occupant 410 as a relative location, such as a location defined by one or more distances relative to known locations of objects (e.g., the headrest 330-1 and/or each of several speakers disposed therein) within the enclosure 108.

As one illustrative example, the apparatus 100 may determine the location of the head 412, the left ear 414, and/or the right ear 416 of the occupant 410 by determining a forward-backward distance (e.g., a distance along they-direction of FIG. 4) between the head 412, the left ear 414, and/or the right ear 416 of the occupant 410 and the headrest 330-1, a lateral distance (e.g., a distance along the x-direction of FIG. 4) between the head 412, the left ear 414, and/or the right ear 416 of the occupant 410 from a centroid of the headrest 330-1, and/or a vertical distance (e.g., a distance along a direction substantially perpendicular to the x-direction and the y-direction of FIG. 4) between the head 412, the left ear 414, and/or the right ear 416 of the occupant 410 from a centroid of the headrest 330-1.

The apparatus 100 (e.g., processor 190) may modify an audio output (e.g., an audio output 400 from a first tweeter 118-T, an audio output 402 from a second tweeter 118-T, and an audio output 404 from a woofer 118-W) of the speakers mounted in the headrest 330-1 relative to an audio output of at least one additional speaker (e.g., an audio output 406 from a speaker 118 mounted in the access feature 114) based on the determined location. In various use cases, the apparatus 100 may modify the volume, the timing, the direction, the binaural reverb, and/or other aspects of the audio output(s) based on the determined location.

For example, as can be seen in FIG. 4, location of the head 412 of the occupant 410 may be significantly closer to the speakers mounted in the headrest 330-1 than the head 412 of the occupant 410 is to the speaker(s) mounted in the access feature 114. For this reason, when the occupant 410 moves and/or turns their head 412, the acoustic balance between the speakers mounted to the headrest 330-1 and the speaker(s) mounted in the access feature 114 (or elsewhere in the enclosure 108) can change by an amount that is noticeable to the occupant 410 and that negatively affects the occupant's acoustic experience within the enclosure 108. For example, the volume of the audio output received at the location of the occupant's head 412 from the speakers mounted in the headrest 330-1 may change more than the volume of the audio output received at the location of the occupant's head 412 from the additional speaker mounted in the access feature 114. Thus, in accordance with one or more aspects of the disclosure, when the apparatus determines that the location of the head 412, the left ear 414, and/or the right ear 416 of the occupant has changed, the apparatus 100 (e.g., processor 190) may modify a volume of the audio output (e.g., the audio output 400, the audio output 402, and/or the audio output 404) of the speakers mounted in the headrest 330-1 relative to a volume of the audio output 406 of the additional speaker(s) in the access feature 114, based on the determined location.

Moreover, due to the smaller distance between the head 412 of the occupant 410 and the speakers mounted in the headrest 330-1 than the distance between the head 412 of the occupant 410 of the additional speaker(s) mounted in the access feature 114, the apparatus 100 may delay the audio output of the speakers mounted in the headrest 330-1 by a delay time relative to an output time of the audio output from the additional speaker(s) mounted in the access feature 114, so that the audio outputs arrive at the location of the occupant's head 412 at the same time. In one or more implementations, when the apparatus 100 determines a change in the location of the head 412, the left ear 414, and/or the right ear 416 of the occupant, the apparatus 100 may also, or alternatively, modify a delay time of the audio output (e.g., the audio output 400, the audio output 402, and/or the audio output 404) of the speakers mounted in the headrest 330-1 relative to an output time of the audio output 406 of the additional speaker(s) in the access feature 114, based on the determined location. In this manner, the apparatus 100 can adaptively cause the audio output 400, the audio output 402, and/or the audio output 404 of the speakers mounted in the headrest 330-1 and the audio output 406 of the additional speaker(s) in the access feature 114 to arrive at the location of the occupant's head 412 at the same time, independent of normal motions of the occupant's head.

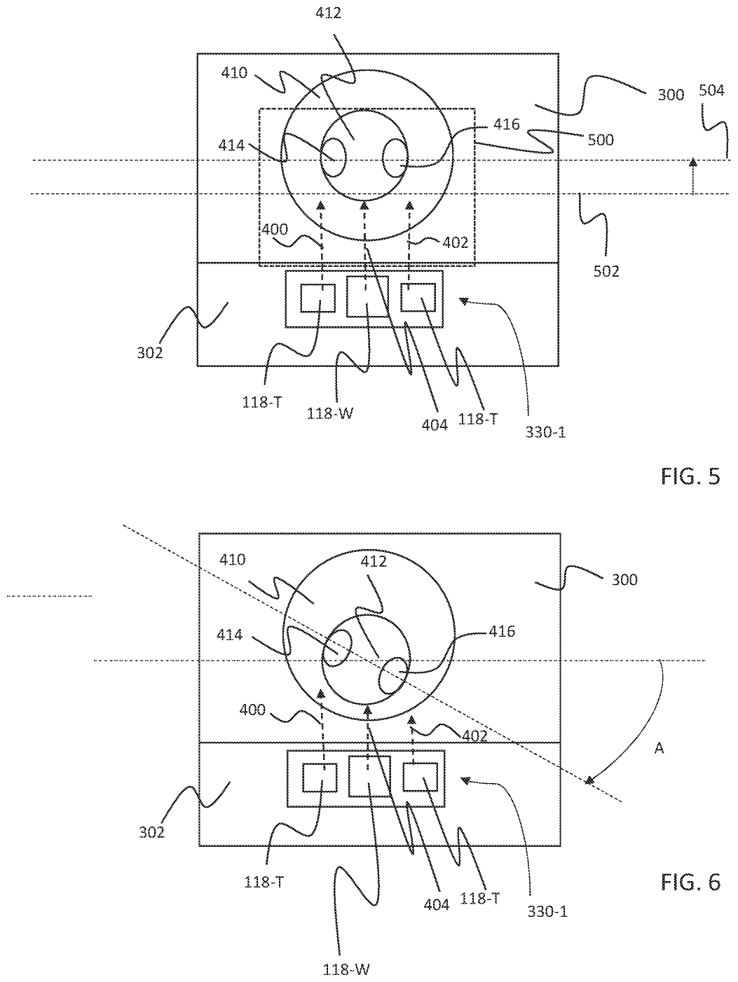

FIG. 5 illustrates a top view of the portion of the apparatus 100 of FIG. 4 around the seat 300 in which the occupant 410 is seated. In the example of FIG. 5, the head 412 of the occupant 410 (e.g., and both the left ear 414 and the right ear 416 of the occupant 410) are disposed within the near field 500 of the speakers (e.g., the tweeters 118-T and the woofer 118-W) mounted in the headrest 330-1. For example, the near field 500 may be region of space in which sound pressure and acoustic particle velocity generated by the speakers in the headrest 330-1 are not in phase. The near field of a speaker may extend, for example, to a distance from the speaker that is one, two, three, or several times a largest dimension of the speaker. In contrast, the far field of a speaker may a region of space in which the sound pressure and acoustic particle velocity are in phase.

In the example of FIG. 5, the head 412 of the occupant 410 (e.g., and both the left ear 414 and the right ear 416 of the occupant 410) has moved from a first distance 502 from the headrest 330-1 to a second distance 504, further from the headrest 330-1, both the first distance 502 and the second distance 504 being within the near field of the speakers (e.g., the tweeters 118-T and the woofer 118-W) mounted to the headrest 330-1. In this example, the apparatus 100 may increase the volume, reduce a delay time, and/or modify a binaural reverb of the audio output 400, the audio output 402, and the audio output 404 to compensate for the increased distance to the occupant's head and ears. Within the near field 500, changes to the acoustic experience may be noticeable to the occupant 410 when changes in distance from the speakers of the headrest 330-1 may are greater than, as examples, one millimeter (mm), five mm, ten mm, fifty mm, one half centimeter (cm), one cm, or greater than two cm. For example, in a use case in which the second distance 504 is one centimeter from the first distance 502, the acoustic power received by the occupant 410 may be reduced by one decibel, which may be noticeable to the occupant. In one or more implementations, the apparatus 100 may increase the volume of the audio output 400, the audio output 402, and/or the audio output 404 by approximately one decibel for each one centimeter of increased distance, within the near field, from the occupant's head 412 to the speakers of the headrest 330-1. In one or more implementations, to prevent acoustic changes at the location of the head and/or ears of the occupant 410 greater than a just-noticeable-difference of 0.5 dB, the apparatus 100 may track the location of the head 412, the left ear 414, and/or the right ear 416 of the occupant 410 (e.g., using the camera(s) 111 and/or sensors 113) with an accuracy of, for example, +/- 5-mm. In one or more implementations, the apparatus 100 may track the location of the head 412, the left ear 414, and/or the right ear 416 of the occupant 410 by determining the location of the head 412, the left ear 414, and/or the right ear 416 of the occupant 410 every millisecond (ms), every ten ms, every thirty ms, every fifty ms, every one hundred ms, or several times per second (as examples).

In one or more implementations, the apparatus 100 may determine that a location (e.g., the second distance 504) is different from a previously determined location (e.g., the first distance 502) of the portion of the head of the occupant by a change in location of at least a threshold distance (e.g., five millimeters, fifty millimeters, one hundred millimeters, one half centimeter, or one centimeter), and modify the audio output of the speakers mounted in the headrest 330-1 relative to the audio output of the speaker(s) mounted in the access feature 114 (and/or other speakers 118 within the enclosure 108) to compensate for the change in location.

In the example of FIG. 5, the new location (e.g., at the second distance 504) of the head 412 of the occupant 410 is within the near field 500 of the speakers mounted to the headrest 330-1. In a use case in which the occupant 410 moves their head 412 out of the near field 500 (e.g., by leaving the seat 300, leaning far forward, or laying down in the seat 300), the apparatus 100 determine that the location of the head 412 (e.g., and/or the left ear 414 and/or the right ear 416) is outside of the near field 500 of the speakers mounted in the headrest, and may modify the audio output of speakers mounted in the headrest 330-1 relative to the audio output of the at least one additional speaker based on the determined location by deactivating, powering off, or reducing the volume of the speakers mounted in the headrest 330-1.

In the example of FIG. 5, the occupant's head 412 has moved uniformly away from the headrest 330-1 such that the left ear 414 and the right ear 416 have both moved away from the headrest 330-1 by the same distance. FIG. 6 illustrates another use case in which the occupant 410 has turned their head 412 (e.g., by an angle A). In this example use case, the occupant's left ear 414 has moved away from the headrest 330-1 and the occupant's right ear 416 has moved toward the headrest 330-1. In this example, the apparatus 100 may modify an audio output of one of the speakers mounted in the headrest 330-1 relative to another of the speakers mounted in the headrest 330-1 based on a determined location of the head 412 (e.g., based on a determination that the orientation of the head 412 has changed and/or a determination that the left ear 414 and the right ear 416 have moved differently). For example, as illustrated in FIG. 6, the apparatus 100 may increase the volume of the audio output 400 and decrease the volume of the audio output 402 to compensate, respectively, for the increased distance of the left ear 414 and the decreased distance of the right ear 416 of the occupant 410 from the headrest 330-1 and/or the speakers mounted therein.

In one or more implementations, the apparatus 100 may also adjust the timing of the audio output 400 relative to the timing of the audio output 402 to compensate for the increased distance of the left ear 414 and the decreased distance of the right ear 416 of the occupant 410 from the headrest 330-1 and/or the speakers mounted therein. For example, the apparatus 100 may decrease a delay time of the audio output 400 and increase a delay time of the audio output 402 to compensate for the increased distance of the left ear 414 and the decreased distance of the right ear 416 of the occupant 410 from the headrest 330-1. In this manner, the apparatus 100 can cause the same audio content in the audio output 400, the audio output 402, and the audio output 404 (e.g., and the audio output 406 of FIG. 4) to arrive at the ears of the occupant 410 at substantially the same time. In one or more implementations, the apparatus 100 may also adjust a binaural reverb of the audio output 400, the audio output 402, and/or the audio output 404 to compensate for the increased distance of the left ear 414 and the decreased distance of the right ear 416 of the occupant 410 from the headrest 330-1 and/or the speakers mounted therein.

In one example use case, the apparatus 100 may determine that the head 412 of the occupant 410 is turned relative to a prior orientation of the head 412 of the occupant 410, and modify the audio output of the one of the plurality of speakers mounted in the headrest relative to the other of the plurality of speakers mounted in the headrest based on the determined location by modifying a volume and a delay time of the audio output of the one of the plurality of speakers mounted in the headrest relative to a volume and a delay time of the other of the plurality of speakers mounted in the headrest.

In various use cases, the audio output 400, the audio output 402, and the audio output 404 from the speakers of the headrest 330-1 may include audio content such as music, audio corresponding to video content being displayed on a display (e.g., display 110), general notification content intended for multiple occupants, personalized notification content for the occupant 410, or any other audio content. In some uses cases, the audio output 400, the audio output 402, and/or the audio output 404 may include noise cancelling content. For example, the apparatus 100 may include one or more microphones, such as microphone 119 (FIG. 2), and may determine, using microphone signals from the one or more microphones, ambient noise (e.g., including vehicle noise and/or road noise) within the enclosure 108 (e.g., in the vicinity of the headrest 330-1). In one or more implementations, one or more microphones may be mounted in and/or to the headrest 330-1 and/or any other headrest. The apparatus 100 may generate (e.g., based on the microphone signals from the microphone(s)) noise cancelling content for inclusion in the audio output 400, the audio output 402, and/or the audio output 404 for substantially cancelling, or reducing, the ambient noise for the occupant 410.

For example, FIG. 7 illustrates a use case in which the audio output 400, the audio output 402, and/or the audio output 404 includes noise cancelling content for generating a noise cancelling region 700 around at least a portion of the head 412 of the occupant 410. In this example, the noise cancelling region 700 may be a bubble of relative quiet around the head 412 of the occupant 410, in which at least some of the ambient noise within the enclosure is cancelled by the noise cancelling content in the audio output 400, the audio output 402, and/or the audio output 404. When the occupant 410 moves their head 412, the apparatus 100 may determine a new location of the head 412, and may modify the audio output 400, the audio output 402, and/or the audio output 404 based on the determined new location, to move the noise cancelling region 700 to the new location.

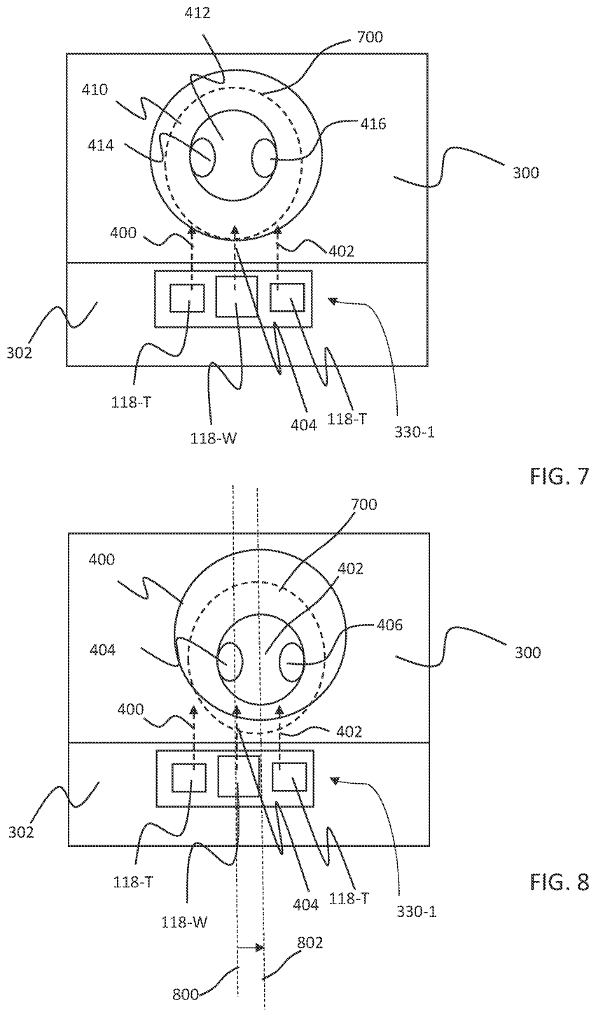

For example, FIG. 8 illustrates a use case in which the occupant 410 has moved their head 412 laterally (e.g., along the x-direction of FIG. 4) from a first lateral position 800 to a second lateral position 802 (e.g., by sliding or moving on the seat 300). In this example, the apparatus 100 has modified the audio output 400, the audio output 402, and/or the audio output 404 to steer the noise cancellation region 700 to follow the location of the head 412 of the occupant 410.

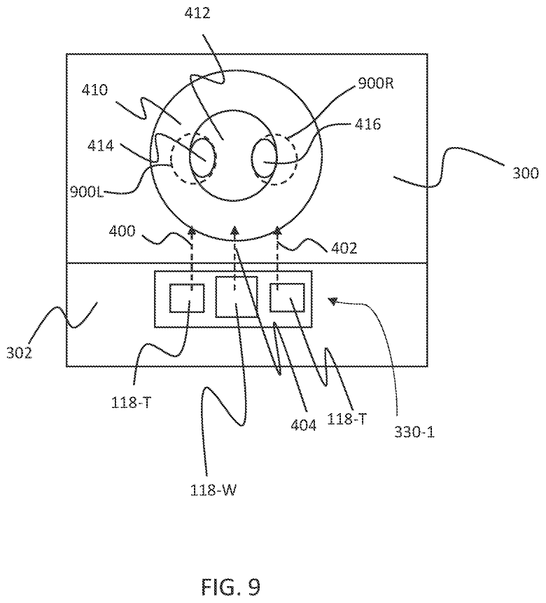

In the example of FIGS. 7 and 8, the noise cancelling region 700 has a size sufficient to encompass the entire head 412 of the occupant 410. In this example, for noise cancelling operations, the apparatus 100 may track the overall location of the head 412 using the sensors 113 and/or the camera(s) 111. In one or more other implementations, the apparatus may track the locations of each of the ears (e.g., the left ear 414 and the right ear 416) of the occupant 410, and may generate individual noise cancelling regions for each of the ears. For example, FIG. 9 illustrates an example in which the apparatus 100 determines (e.g., and tracks) each ear of the occupant 410, and the audio output 400, the audio output 402, and/or the audio output 404 generate multiple noise cancelling regions, each having a size sufficient to encompass an ear of the occupant 410. In this example, the audio output 400, the audio output 402, and/or the audio output 404 generates a noise-cancelling region 900L around the left ear 414 and a noise cancelling region 900R around the right ear 416 of the occupant 410. In this example, the apparatus 100 may track (e.g., using sensors 113 and/or camera(s) 111) the locations of each of the left ear 414 and the right ear 416 (e.g., by determining the location the left ear 414 and the right ear 416 once every ten milliseconds (ms), once every fifty ms, once every one hundred ms, several times per second, etc.), and modify the audio output 400, the audio output 402, and/or the audio output 404 (e.g., and/or audio output from one or more additional speakers in the headrest 330-1 such as an additional woofer 118-W in the headrest 330-1) to steer the locations of the noise-cancelling region 900L and the noise cancelling region 900R to follow, respectively, the left ear 414 and the right ear 416 of the occupant 410.

In the examples of FIGS. 5-9, examples are described in which the apparatus 100 determines and/or tracks changes in the location of the head 412, the left ear 414, and/or the right ear 416 of the occupant 410 as a result of separate forward-backward motions, rotations, and lateral motions of the head 412. It is also appreciated that the apparatus 100 can also track motions of location of the head 412, the left ear 414, and/or the right ear 416 of the occupant 410 in other directions, such as a vertical direction, and/or other rotations such as forward-backward tips or left-right tilts of the occupant's head 412, and adjust the audio output(s) of the speaker(s) in a headrest accordingly. For example, in one or more implementations, the audio output(s) of the speaker(s) in a headrest may be adjusted and/or modified based on a vertical location of the user's head (e.g., relative to a centroid of a headrest and/or one or more speakers disposed therein, in a direction perpendicular to the x-direction and the y-direction of FIGS. 3 and 4) to direct the audio outputs upward to downward to compensate for differences in height and/or posture of different occupants of a seat. It is also appreciated that the apparatus can also track any combination of forward-backward motions, rotations, lateral motions, vertical motions, forward-backward tips, and/or left-right tilts of the head 412 of an occupant 410, and adjust the audio output(s) of the speaker(s) in a headrest accordingly.

Although various examples described herein relate to one occupant 410 in one seat 300, similar operations may be performed for one occupant 410 in any other seat, and/or for each of several occupants in each of several seats having headrests with speakers.

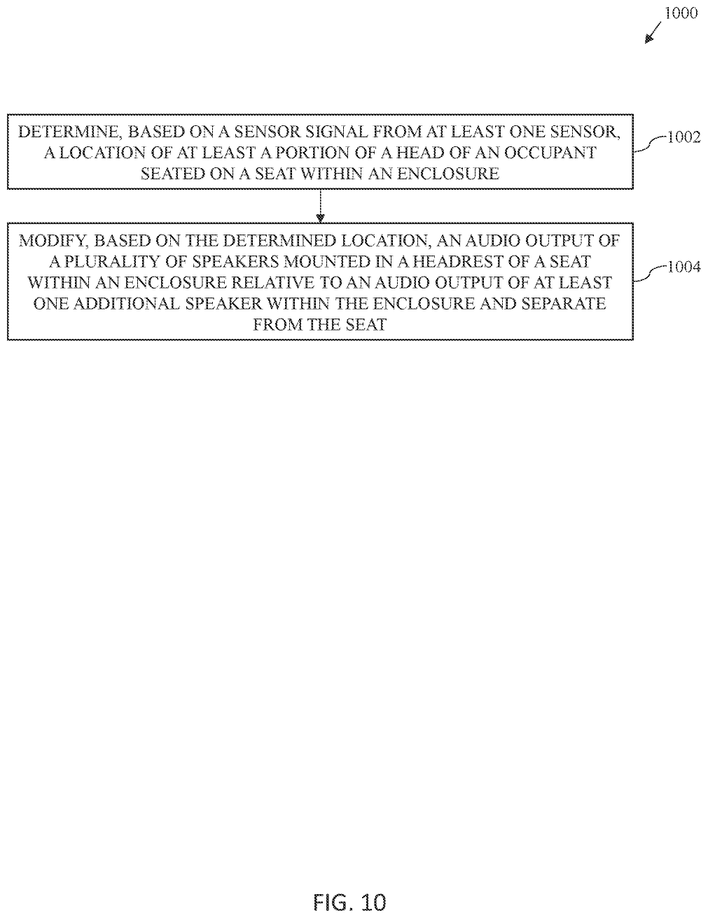

FIG. 10 illustrates a flow diagram of an example process 1000 for providing user tracking headrest audio control, in accordance with implementations of the subject technology. For explanatory purposes, the process 1000 is primarily described herein with reference to the apparatus 100 of FIGS. 1 and 2. However, the process 1000 is not limited to the apparatus 100 of FIGS. 1 and 2, and one or more blocks (or operations) of the process 1000 may be performed by one or more other components of other suitable devices or systems. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, a location of at least a portion of a head (e.g., head 412) of an occupant (e.g., occupant 410) seated on a seat (e.g., seat 300, seat 310, seat 312, or seat 314) within an enclosure (e.g., enclosure 108 of apparatus 100) may be determined (e.g., by apparatus 100, such as by processor 190) based on a sensor signal from at least one sensor (e.g., a sensor such as a sensor 113 or camera 111 described herein). The portion of the head of the occupant may include the entire head of the occupant, or may include one or each of the ears of the occupant.

Determining the location may include capturing one or more images using one or more cameras 111 (e.g., one or more visible wavelength cameras, one or more infrared cameras, and/or one or more visible wavelength light sources and/or one or more infrared light sources), and/or obtaining other scene information (e.g., depth sensing and/or scene mapping information) using one or more sensors 113, and determining the location based on the images and/or the scene information (e.g., by applying computer vision and/or object detection processes to the images and/or scene information). In one or more implementations, determining the location may include determining a change in the location. For example, in one or more implementations, an apparatus such as the apparatus 100 may repeatedly determine the location of at least the portion of the head of the occupant (e.g., several times per minute, once per minute, several times per second, once every 10-100 milliseconds, etc.) over time for tracking of at least the portion of the head of the occupant.

At block 1004, an audio output of a plurality of speakers (e.g., one or more tweeters 118-T and/or one or more woofers 118-W) mounted in a headrest (e.g., headrest 330-1) of the seat may be modified relative to an audio output of at least one additional speaker (e.g., a speaker 118 mounted in an access features 114, or another speaker 118) within the enclosure and separate from the seat. In one or more implementations in which determining the location includes determining a change in the location, modifying the audio output of the plurality of speakers mounted in the headrest relative to the audio output of at least one additional speaker may include modifying at least one of a volume or a timing of the audio output of the plurality of speakers mounted in the headrest to compensate for the change in the location (e.g., as described herein in connection with FIGS. 5-9).

In one or more implementations, the process 1000 may include determining that the location is greater than a threshold distance from (e.g., outside of a near field, such as the near field 500 of) the plurality of speakers mounted in the headrest, and (e.g., responsive to determining that the location is greater than the threshold distance) ceasing the audio output from the plurality of speakers mounted in the headrest while continuing to generate the audio output from the at least one additional speaker. For example, in a use case in which an occupant (e.g., occupant 410) is seated in the seat 300 lays down on the seat, moving their head out of the near field of the speakers in the headrest 330-1, the speakers in the headrest 330-1 may be powered down or deactivated (e.g., until the occupant sits up and moves their head back to within the near field of the speakers in the headrest). In this example, one or more other speakers within the enclosure (e.g., speakers that were already in the far field of the occupant's head) may continue to generate audio output, and/or may be newly activated based on a new location of the occupant's head and/or ears.

In one or more implementations, modifying the audio output of the plurality of speakers mounted in the headrest relative to the audio output of the at least one additional speaker based on the determined location may include modifying a volume of the audio output of the plurality of speakers mounted in the headrest relative to a volume of the audio output of the at least one additional speaker based on the determined location. In one or more implementations, modifying the audio output of the plurality of speakers mounted in the headrest relative to the audio output of the at least one additional speaker based on the determined location may include modifying a delay time of the audio output of the plurality of speakers mounted in the headrest relative to an output time of the audio output of the at least one additional speaker based on the determined location.

In one or more implementations, the process 1000 may also include modifying an audio output of one of the plurality of speakers mounted in the headrest relative another of the plurality of speakers mounted in the headrest based on the determined location (e.g., as described herein in connection with FIG. 6, 8, and/or 9). In one or more implementations, the process 1000 may include determining, based on the location, that the head of the user is turned relative to a prior orientation of the head of the user (e.g., as described herein in connection with FIG. 6), and modifying the audio output of the one of the plurality of speakers mounted in the headrest relative to the other of the plurality of speakers mounted in the headrest based on the determined location may include modifying a volume and/or a delay time of the audio output of the one of the plurality of speakers mounted in the headrest relative to a volume and/or a delay time of the other of the plurality of speakers mounted in the headrest.

In one or more implementations, the process 1000 may also include operating the plurality of speakers mounted in the headrest based on an input to a microphone (e.g., a microphone 119 mounted in the enclosure 108, such as mounted in or near a headrest), to generate a noise cancelling region (e.g., a noise cancelling region 700, a noise-cancelling region 900L and/or a noise-cancelling region 900R) around at least the portion of the head of the occupant. In one or more implementations, the process 1000 may also include modifying an audio output of one of the plurality of speakers mounted in the headrest relative to another of the plurality of speakers mounted in the headrest based on the determined location to move the noise cancelling region to the location (e.g., to steer the noise cancelling region based on occupant head movements, such as is described herein in connection with FIGS. 8 and/or 9). In one or more implementations, the portion of the head of the occupant includes the entire head of the occupant, and the noise cancelling region (e.g., noise cancelling region 700) has a size sufficient to encompass the entire head of the occupant (e.g., as described herein in connection with FIGS. 7 and 8). In one or more other implementations, the portion of the head of the occupant includes an ear of the occupant and the noise cancelling region (e.g., noise-cancelling region 900L or noise cancelling region 900R) has a size sufficient to encompass the ear of the occupant (e.g., as described herein in connection with FIG. 9).

Various examples are described herein in which headrest audio control is provided to operate speakers mounted to a headrest of a seat based a location of head and/or one or both ears of an occupant of the seat. It is also appreciated that the headrest audio control described herein can be applied to operate, based a location of head and/or one or both ears of an occupant of the seat, one or more speakers mounted elsewhere in a seat (e.g., at or near a top end of a seat that does not include a headrest), and/or at any or other location(s) at which the head and/or ears of a person are within the near field of the speaker(s).

In the examples of FIGS. 5-10, head tracking is described that can be used to modify the operations of one or more speakers, such as headrest speakers mounted in a headrest of a seat of an apparatus (e.g., a vehicle). In these examples, modifying the operations of the speaker(s) based on the location and/or orientation of an occupant's head and/or ears can reduce unwanted auditory effects caused by motion of the user's head and/or ears relative to the locations of the speakers in the headrest (e.g., speakers that are near the user's head and/or ears, and for which small motions of the user's head and/or ears can cause noticeable changes in audio volume and/or arrival times).

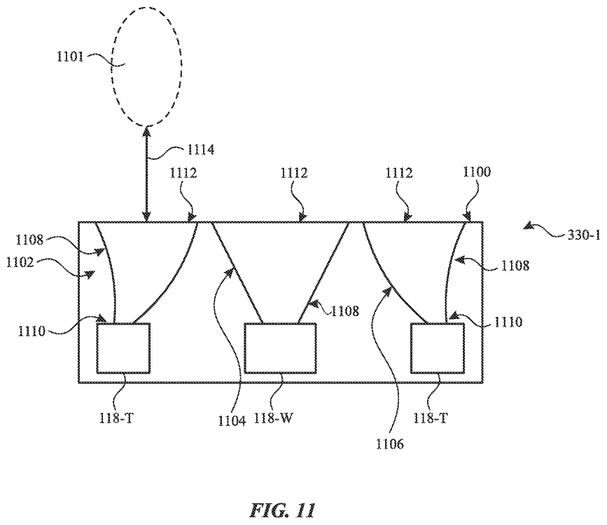

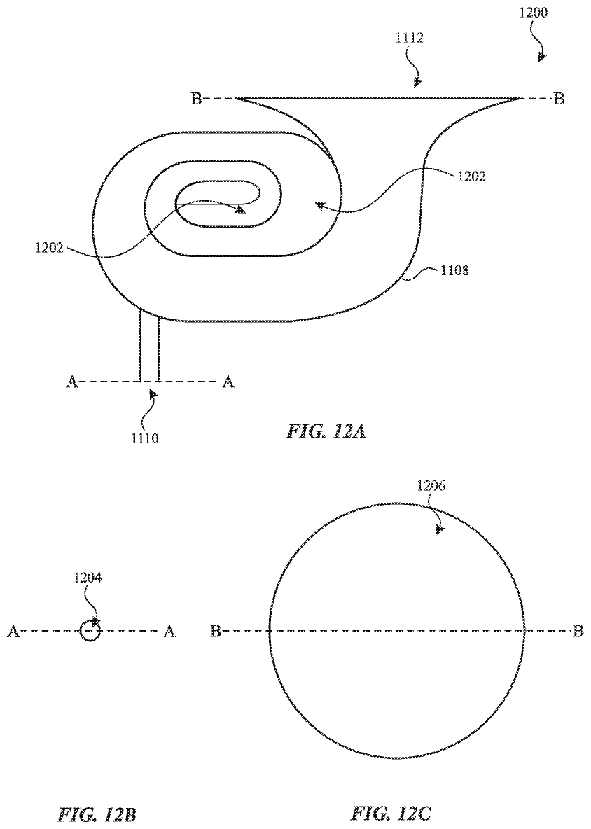

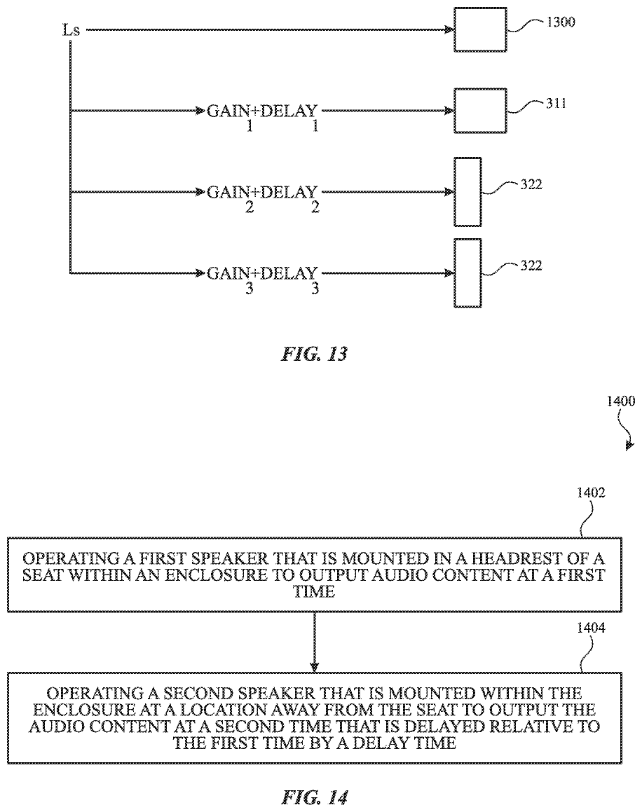

In one or more implementations, these unwanted auditory effects can also, or alternatively, be mitigated by increasing the effective size of a speaker in the headrest (e.g., relative to the distance between the headrest speaker and the occupant's ear), and/or using distributed reverb operations to reduce the perceptual importance of motions relative to the headrest speaker to the occupant's listening experience (e.g., while mainlining the perception that the sound the occupant hears is primarily coming from the headrest speaker). FIGS. 11 and 12 illustrate implementations in which the effective size of a headrest speaker is increased. FIGS. 13 and 14 illustrate aspects of distributed reverb operations.

FIG. 11 illustrates a top view of a headrest in an implementation in which the effective area of one or more headrest speakers is increased, such as to reduce or mitigate the effect of motions of the head and/or ears of an occupant relative to the headrest speaker. As shown in FIG. 11, a headrest 330-1 includes multiple speakers having corresponding horns. In various implementations, the headrest 330-1 may be permanently or removably attached to the seat back 302 of the seat 300 as described herein in connection with FIG. 3, or may be formed from a portion of the seat back 302. In the example of FIG. 11, headrest 330-1 includes a head-interface surface 1100 and multiple speakers mounted to (e.g., within) the headrest 330-1. The head-interface surface 1100 may be a surface of the headrest that is arranged to contact the back of a head (e.g., a head 412) of an occupant (e.g., an occupant 410) when the occupant is seated in the seat 300 and resting their head against the headrest. In this example, headrest 330-1 includes two tweeters 118-T and one woofer 118-W. However, in other implementations, the headrest 330-1 may include more than three speakers, fewer than three speakers, more or fewer than two tweeters, and/or more than one woofer.

In one or more implementations, the headrest speakers (e.g., tweeters 118-T and one woofer 118-W) may be mounted within the headrest 330-1. As shown in FIG. 11, one or more of the headrest speakers may include a horn that increases the effective area of the speaker. In the example of FIG. 11, the tweeter 118-T at the left of the headrest is coupled to a horn 1102, the woofer 118-W is coupled to a horn 1104, and the tweeter 118-T at the right of the headrest is coupled to a horn 1106. This is merely illustrative, and in other implementations, one, two, all, or less than all of the headrest speakers (e.g., speakers that are mounted in a headrest) may be provided with a corresponding horn.

As shown in FIG. 11, each of the horns 1102, 1104, and 1106 may have a body 1108, that includes a first opening 1110 (e.g., a throat) that is acoustically coupled to the speaker, a second opening 1112 (e.g., a mouth) at or near the head-interface surface 1100, and a cross-sectional area that expands along the length of the horn from the first opening 1110 to the second opening 1112 (e.g., from the throat to the mouth).

For example, the second opening 1112 may have a cross-sectional area that similar to (e.g., the same as, larger than, larger than half of, or within twice) a distance 1114 between the head-interface surface 1100 and an ear position 1101 for an occupant of the seat. For example, the ear position 1101 may be a typical (e.g., average or median) location of an ear of a typical (e.g., average or median) occupant when seated in a seat having the headrest 330-1, or may be a measured position of an ear of a current occupant seated in a seat having the headrest 330-1 (e.g., measured using sensors of the apparatus 100).

In the example of FIG. 11, the body 1108 of the horn 1104 has straight walls and a linearly increasing cross-sectional area along the length of the body from the first opening 1110 to the second opening 1112. In this example, the bodies 1108 of the horns 1102 and 1106 have curved walls and a cross-sectional area that increases non-linearly along the length of the body from the first opening 1110 to the second opening 1112. In this example, the horns 1102 and 1106 each extend along a curved path within the headrest 330-1 between the throat (e.g., first opening 1110) and the mouth (e.g., second opening 1112) of the horn. These implementations of the horns 1102, 1104, and 1106 are merely illustrative, and other arrangements of the horns are contemplated.

For example, FIGS. 12A-C illustrate an example of a horn 1200 that may be provided for a headrest speaker. For example, the horn 1200 of FIG. 12A may be an implementation of any of the horn 1102, the horn 1104, or the horn 1106 of FIG. 11. As shown, the horn 1200 horn extends along a curved path within the headrest between the first opening 1110 (which is configured to be acoustically coupled to the output of a headrest speaker, such as any of the speakers 118-T and/or 118-W of FIG. 11) and the second opening 1112 (which is configured to be mounted at or near the head-interface surface 1100 of a headrest such as the headrest 330-1 described herein). In the example of FIG. 12A, the horn 1200 includes multiple nested windings 1202 that allow the body 1108 of the horn to provide a longer path for expansion of the cross-sectional area within a compact volume of the overall horn. In the example of FIG. 12A, the windings 1202 are regular oblong windings that are substantially concentric. However, in other implementations, the body 1108 of the horn may have irregular windings, non-concentric windings, and/or may follow a torturous path (e.g., a path that bends around other structures of a headrest, such as mechanical and/or support structures) between the first opening 1110 and the second opening 1112.

FIG. 12B shows the cross-sectional area 1204 of the body 1108 taken along the line A-A at the first opening 1110, and FIG. 12C shows the cross-sectional area 1206 of the body 1108 taken along the line B-B at the second opening 1112, showing how the cross-sectional area 1206 is larger than the cross-sectional area 1204, thereby increasing the effective size of the speaker to which the first opening 1110 is acoustically coupled. As discussed herein, an increased effective speaker size can mitigate acoustic effects that can be caused by movement of an occupant's head and/or ears relative to the location of the speaker.

In one or more implementations, acoustic effects that can be caused by movement of an occupant's head and/or ears relative to the location of the speaker may also, or alternatively, be mitigated by applying distributed reverb to the audio output of the speaker. FIG. 13 is a diagram illustrating a distributed reverb operation that can be performed in an enclosure having multiple speakers.

As shown in FIG. 13, an audio signal (Ls) may be provided to a headrest speaker 1300 for output by that speaker. For example, the headrest speaker 1300 may be an implementation of a tweeter 118-T or a woofer 118-W that are described herein as being mounted to (e.g., within) a headrest of a seat in an enclosure, or may be any other speaker that can be mounted to (e.g., within) a headrest of a seat in an enclosure. As shown, the same audio signal (Ls) may be provided to one or more other speakers (e.g., the speaker 311, and/or the beamforming speaker arrays 322 described herein) that are mounted in the enclosure at locations that are spatially separated from the headrest, with a gain and/or a delay time for that speaker applied to the audio signal.

In the example of FIG. 13, the audio signal Ls is provided to the speaker 311 with a first gain (e.g., Gaini) and a first delay time (e.g., Delayi), to a first beamforming speaker array 322 (e.g., a beamforming speaker array 322 mounted to or within a left side door of the enclosure) with a second gain (e.g., Gain2) and a second delay time (e.g., Delay2) , and to a second beamforming speaker array 322 (e.g., a beamforming speaker array 322 mounted to or within a right side door of the enclosure) with a third gain (e.g., Gain3) and a third delay time (e.g., Delay3). For example, the first, second, and third delay times may cause the speaker 311, the first beamforming speaker array 322, and the beamforming speaker array 322 respectively to output the same audio content that is output by the headrest speaker 1300, but at later respective times. In this way, the combined outputs of the headrest speaker 1300, the speaker 311, and the beamforming speaker arrays 322 can generate a distributed reverb effect within the enclosure.

For example, the first delay time, the second delay time, and the third delay time may each be less than an echo threshold time. An echo threshold time may be a time after which a delayed output of the same audio content from another speaker may be perceived by an occupant in the enclosure as an echo of the output from the headrest speaker. In one or more implementations, the echo threshold time may be approximately 20 milliseconds, 30 milliseconds, 40 milliseconds, 50 milliseconds, or 100 milliseconds (as examples). In one or more implementations, the echo threshold time may be determined based on a geometry (e.g., a size) of the enclosure 108. In one or more implementations, the first delay time, the second delay time, and the third delay time may each be between, for example, 5 milliseconds and 30 milliseconds. For example, outputting the same audio content (e.g., the audio content of the audio signal Ls) as is output by the headrest speaker 1300 from other speakers with delay times between 5 milliseconds and 30 milliseconds may cause these delayed audio outputs to be perceived by the occupant as part of the various reflections/reverberations of the audio output of the headrest speaker 1300 within the enclosure 108, thus creating a distributed reverb effect.

In various implementations, the first delay time, the second delay time, and the third delay time may be the same as each other, or one or more of the first delay time, the second delay time, and the third delay time may be different from one or more others of the first delay time, the second delay time, and the third delay time. In this way, the distribution of the reverb within the enclosure may be controlled, in part, by controlling the first delay time, the second delay time, and/or the third delay time. In one or more implementations, the first delay time may be based, in part, on a distance between the headrest speaker 1300 and the speaker 311. The second delay time may be based, in part, on a distance between the headrest speaker 1300 and the first beamforming speaker array 322. The third delay time may be based, in part, on a distance between the headrest speaker 1300 and the first beamforming speaker array 322. In one or more implementations, the first delay time, the second delay time, and/or the third delay time may be based, in part, on one or more others of the first delay time, the second delay time, and the third delay time (e.g., to ensure that the first delay time, the second delay time, and the third delay time are different from each other in some implementations). In one or more implementations, the first gain, the second gain, and/or the third gain may be based on the respective distances between the headrest speaker 1300 and the speaker 301, the first beamforming speaker array 322, and the second beamforming speaker array 322 (e.g., to generate audio outputs from the respective speakers that arrive at the ear(s) of an occupant with the same volume, despite the different distances to the occupant's ear).

In some audio systems, it would be counterintuitive to delay the outputs of speakers that are further away from a listener, relative to the outputs of speakers that are closer to the listener. In these audio systems, it may be desirable to delay the arrival of the output of the nearer speakers, so that the outputs arrive at the user's ears substantially simultaneously. However, in audio systems in which one or more speakers are located very near the user's ears (e.g., audio systems that include speakers in a headrest of a user's seat), generating distributed reverb by delaying the arrivals of the outputs of the spatially more distant speakers can be advantageous, as described herein. In the example of FIG. 11, because the audio output from the headrest speaker 1300 occurs first (e.g., and is received first at the ear of the user), the location of the audio output may be perceived by the occupant as the location of the headrest speaker. In addition, because the same audio content is being output by one or more other speakers within the 5-30 millisecond (for example) delay time window, the resulting reverb of the overall output may mitigate any perceptual effects of small movements of the occupant's head and/or ears relative to the location of the headrest speaker. These distributed reverb operations can be applied without, or in combination with, the head tracking audio output described herein in connection with any or all of FIGS. 5-10. These distributed reverb operations can be applied using headrest speakers 1300 that include or are free of horns, such as the horns described in FIGS. 11 and 12).

FIG. 14 illustrates a flow diagram of an example process 1400 for providing distributed reverb, in accordance with implementations of the subject technology. For explanatory purposes, the process 1400 is primarily described herein with reference to the apparatus 100 of FIGS. 1 and 2. However, the process 1400 is not limited to the apparatus 100 of FIGS. 1 and 2, and one or more blocks (or operations) of the process 1400 may be performed by one or more other components of other suitable devices or systems. Further for explanatory purposes, some of the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

As illustrated in FIG. 14, at block 1402, a first speaker (e.g., a headrest speaker, such as the headrest speaker 1300 of FIG. 13) that is mounted in a headrest (e.g., headrest 330-1) of a seat (e.g., seat 300) within an enclosure (e.g., enclosure 108) may be operated to output audio content (e.g., audio content included in an audio signal Ls) at a first time. For example, the first speaker may be a tweeter 118-T mounted in the headrest, and/or a woofer 118-W mounted in the headrest. In one or more implementations, the first speaker may have an associated horn acoustically coupled thereto that increases the effective area of the first speaker at a head-interface surface of the headrest (e.g., as described herein in connection with FIGS. 11 and 12).

At block 1404, a second speaker (e.g., the speaker 311, a beamforming speaker array 322 or a speaker thereof, any other speaker 118 described herein, or any other speaker) that is mounted within the enclosure at a location away from the seat may be operated to output the audio content (e.g., the same audio content based on the same audio signal Ls) at a second time that is delayed relative to the first time by a delay time (e.g., Delay1, Delay2, or Delay3 of FIG. 13). For example, the delay time may be less than an echo threshold time. For example, the echo threshold time may be approximately 30 milliseconds. In one or more implementations, the delay time may be between 5 milliseconds and 30 milliseconds. For example, the delay time may be based in part on a distance between the first speaker and the second speaker.

In one or more implementations, a gain may be applied to the audio output of the second speaker. For example, the gain may cause the output of the audio content from the second speaker to arrive, at a location corresponding to an ear of an occupant in a seat having the headrest, with a volume that is similar to the volume of the output of the first speaker at the location corresponding to the ear of the occupant.

In one or more implementations, the process 1400 may also include operating a third speaker (e.g., another of the speaker 311, a beamforming speaker array 322 or a speaker thereof, any other speaker 118 described herein, or any other speaker) that is mounted within the enclosure at a location away from the seat and the second speaker to output the audio content (e.g., the same audio content based on the same audio signal Ls) at a third time that is delayed relative to the first time by another delay time (e.g., another of Delay1, Delay2, or Delay3 of FIG. 13) different from the delay time.

In one or more implementations, operating the first speaker to output the audio content at the first time and the second speaker to output the audio content at the second time (e.g., and the third speaker to output the audio content at the third time) generates a distributed reverb effect within the enclosure that reduces a perceptual amount of change in the output of the first speaker due to head movements of an occupant of the seat.

Various processes defined herein consider the option of obtaining and utilizing a user's personal information. For example, such personal information may be utilized in order to provide user tracking headrest audio control. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

In accordance with aspects of the subject disclosure, an apparatus is provided that includes an enclosure; a seat within the enclosure and having a headrest; a plurality of speakers mounted in the headrest; at least one additional speaker within the enclosure and separate from the headrest; at least one sensor; and a computing component configured to: determine, based on a sensor signal from the at least one sensor, a location of at least a portion of a head of an occupant within the enclosure; and modify an audio output of the plurality of speakers mounted in the headrest relative to an audio output of the at least one additional speaker based on the determined location.

In accordance with aspects of the subject disclosure, a method is provided that includes determining, based on a sensor signal from at least one sensor, a location of at least a portion of a head of an occupant seated on a seat within an enclosure; and modifying based on the determined location, an audio output of a plurality of speakers mounted in a headrest of the seat relative to an audio output of at least one additional speaker within the enclosure and separate from the seat.

In accordance with aspects of the subject disclosure, a moveable platform is provided that includes an enclosure; a seat within the enclosure and having a headrest; a plurality of speakers mounted in the headrest; at least one sensor; and a computing component configured to: determine, based on a sensor signal from the at least one sensor, a location of at least a portion of a head of an occupant within the enclosure; and modify an audio output of one of the plurality of speakers mounted in the headrest relative to another of the plurality of speakers mounted in the headrest based on the determined location.

In accordance with aspects of the subject disclosure, an apparatus is provided that includes an enclosure; a seat within the enclosure and having a headrest having a head-interface surface; a speaker mounted in the headrest; and a horn having a first opening acoustically coupled to the speaker, a second opening at the head-interface surface, and a cross-sectional area that expands along the length of the horn from the first opening to the second opening.

In accordance with aspects of the subject disclosure, a method is provided that includes operating a first speaker that is mounted in a headrest of a seat within an enclosure to output audio content at a first time; and operating a second speaker that is mounted within the enclosure at a location away from the seat to output the audio content at a second time that is delayed relative to the first time by a delay time.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM.

The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of”60 preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. An apparatus, comprising;
an enclosure;
a seat within the enclosure and having a headrest;
a plurality of speakers mounted in the headrest;
at least one additional speaker within the enclosure and separate from the headrest;
at least one sensor; and
a computing component configured to:
determine, based on a sensor signal from the at least one sensor, a location of at least a portion of a head of an occupant within the enclosure; and
modify an audio output of the plurality of speakers mounted in the headrest relative to an audio output of the at least one additional speaker based on the determined location.

2. The apparatus of claim 1, wherein the computing component is configured to modify the audio output of the plurality of speakers mounted in the headrest relative to the audio output of the at least one additional speaker based on the determined location by modifying a volume of the audio output of the plurality of speakers mounted in the headrest relative to a volume of the audio output of the at least one additional speaker based on the determined location.

3. The apparatus of claim 1, wherein the computing component is configured to modify the audio output of the plurality of speakers mounted in the headrest relative to the audio output of the at least one additional speaker based on the determined location by modifying a delay time of the audio output of the plurality of speakers mounted in the headrest relative to an output time of the audio output of the at least one additional speaker based on the determined location.

4. The apparatus of claim 1, wherein the computing component is configured to:
determine that the location is outside of a near field of the plurality of speakers mounted in the headrest, and
modify the audio output of the plurality of speakers mounted in the headrest relative to the audio output of the at least one additional speaker based on the determined location by deactivating the plurality of speakers mounted in the headrest.

5. The apparatus of claim 1, wherein the computing component is configured to:
determine that the location is different from a previously determined location of the portion of the head of the occupant by a change in location of at least a threshold distance; and
modify the audio output of the plurality of speakers mounted in the headrest relative to the audio output of the at least one additional speaker to compensate for the change in location.

6. The apparatus of claim 1, wherein the at least the portion of the head of the occupant comprises the head of the occupant.

7. The apparatus of claim 1, wherein the at least the portion of the head of the occupant comprises an ear of the occupant.

8. The apparatus of claim 1, wherein the computing component is further configured to modify an audio output of one of the plurality of speakers mounted in the headrest relative to another of the plurality of speakers mounted in the headrest based on the determined location.

9. The apparatus of claim 8, wherein the computing component is further configured to determine, based on the location, that the head of the occupant is turned relative to a prior orientation of the head of the occupant; and
modify the audio output of the one of the plurality of speakers mounted in the headrest relative to the other of the plurality of speakers mounted in the headrest based on the determined location by modifying a volume and a delay time of the audio output of the one of the plurality of speakers mounted in the headrest relative to a volume and a delay time of the other of the plurality of speakers mounted in the headrest.

10. The apparatus of claim 1, further comprising a microphone within the enclosure, wherein the computing component is further configured to operate the plurality of speakers mounted in the headrest based on an input to the microphone, to generate a noise cancelling region around at least the portion of the head of the occupant.

11. The apparatus of claim 10, wherein the computing component is further configured to modify the audio output of one of the plurality of speakers mounted in the headrest relative to another of the plurality of speakers mounted in the headrest based on the determined location to move the noise cancelling region to the location.

12. The apparatus of claim 11, wherein the portion of the head of the occupant comprises an entire head of the occupant and the noise cancelling region has a size sufficient to encompass the entire head of the occupant.

13. The apparatus of claim 11, wherein the portion of the head of the occupant comprises an ear of the occupant and the noise cancelling region has a size sufficient to encompass the ear of the occupant.

14. The apparatus of claim 1, wherein the sensor comprises a camera.

15. The apparatus of claim 14, wherein the sensor further comprises an infrared light source.

16. The apparatus of claim 1, wherein the plurality of speakers mounted in the headrest comprise at least two tweeters, and at least one woofer.

17. A method, comprising:
determining, based on a sensor signal from at least one sensor, a location of at least a portion of a head of an occupant seated on a seat within an enclosure; and
modifying based on the determined location, an audio output of a plurality of speakers mounted in a headrest of the seat relative to an audio output of at least one additional speaker within the enclosure and separate from the seat.

18. The method of claim 17, wherein determining the location comprises determining a change in the location, and wherein modifying the audio output of the plurality of speakers mounted in the headrest relative to the audio output of the at least one additional speaker comprises modifying at least one of a volume or a timing of the audio output of the plurality of speakers mounted in the headrest to compensate for the change in the location.

19. The method of claim 17, further comprising:
determining that the location is greater than a threshold distance from of the plurality of speakers mounted in the headrest; and
ceasing the audio output from the plurality of speakers mounted in the headrest while continuing to generate the audio output from the at least one additional speaker.

20. A moveable platform, comprising:
an enclosure;
a seat within the enclosure and having a headrest;
a plurality of speakers mounted in the headrest;
at least one sensor; and
a computing component configured to:
determine, based on a sensor signal from the at least one sensor, a location of at least a portion of a head of an occupant within the enclosure; and
modify an audio output of one of the plurality of speakers mounted in the headrest relative to another of the plurality of speakers mounted in the headrest based on the determined location.

21. An apparatus, comprising;
an enclosure;
a seat within the enclosure and having a headrest having a head-interface surface;
a speaker mounted in the headrest; and
a horn having a first opening acoustically coupled to the speaker, a second opening at the head-interface surface, and a cross-sectional area that expands along the length of the horn from the first opening to the second opening.

22. The apparatus of claim 21, wherein the second opening has a cross-sectional area that is larger than a distance between the head-interface surface and an ear position for an occupant of the seat.

23. The apparatus of claim 21, wherein the horn extends along a curved path within the headrest between the first opening and the second opening.

24. The apparatus of claim 21, further comprising an additional speaker mounted in the headrest, and an additional horn having a throat acoustically coupled to the additional speaker, a mouth at the head-interface surface, and a cross-sectional area that expands along the length of the horn from the throat to the mouth.

25. A method, comprising:
operating a first speaker that is mounted in a headrest of a seat within an enclosure to output audio content at a first time; and
operating a second speaker that is mounted within the enclosure at a location away from the seat to output the audio content at a second time that is delayed relative to the first time by a delay time.

26. The method of claim 25, wherein the delay time is less than an echo threshold time.

27. The method of claim 26, wherein the echo threshold time is approximately 30 milliseconds.

28. The method of claim 27, wherein the delay time is between 5 milliseconds and 30 milliseconds.

29. The method of claim 26 wherein the delay time is based in part on a distance between the first speaker and the second speaker.

30. The method of claim 25, further comprising operating a third speaker that is mounted within the enclosure at a location away from the seat and the second speaker to output the audio content at a third time that is delayed relative to the first time by another delay time different from the delay time.

31. The method of claim 25, wherein operating the first speaker to output the audio content at the first time and the second speaker to output the audio content at the second time generates a distributed reverb effect within the enclosure that reduces a perceptual amount of change in the output of the first speaker due to head movements of an occupant of the seat.
